(19) United States
(12) Patent Application Publication
(10) Pub. No.: US 2010/0230848 A1
(43) Pub. Date: Sep. 16, 2010

(54) CUTTER

(75) Inventors: JUN-LIANG MIAO, Shenzhen City (CN); ZHI-QIANG CHEN, Shenzhen City (CN); SHAO-FENG CAI, Shenzhen City (CN); CHUN-BIN ZHENG, Shenzhen City (CN); QING-XIANG ZENG, Shenzhen City (CN); YI-YANG SONG, Shenzhen City (CN); GUO-YANG CAO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/479,924

(22) Filed: Jun. 8, 2009

(30) Foreign Application Priority Data
Mar. 13, 2009 (CN) 200910300838.1

(51) Int. Cl. B29C 45/38; B26D 3/00

(52) U.S. Cl. 264/161; 425/289; 407/114

(57) ABSTRACT

A cutter includes a contacting surface, a stopping surface. The cutter defines a cutting hole through the contacting surface and the stopping surface, forming a cutting chin on the stopping surface. A molding assembly is also provided.

### BACKGROUND

1. Technical Field

The present disclosure relates to cutters and, particularly, to a cutter used in insert-molding.

2. Description of Related Art

Many electronic elements are manufactured by insert-molding. Insert-molding is a method that injects hot-melted plastic into a molding chamber to form an electronic element via a hot-runner. The hot-runner communicates with the molding chamber via a channel. When the molding chamber is cooled, a connecting head is usually formed in the channel, connected to the product, i.e., the electronic element. Thus, a cutter has to be used to sever the connecting head from the product.

A typical cutter has a wedge head portion. The head portion forms its cutting chin at a front. To sever a connecting head, the cutter is mounted in a thimble hole of a male mold of the molding assembly and driven to move towards a female mold along the thimble hole by the insert-molding machine. Thus, the cutting chin of the cutter can sever the connecting head along the connecting portion between the connecting head and the product.

However, the cutter may be extruded towards the product and further hit the female mold during the cutting process, which not only destroys the cutter, but also make the connecting portion have a burr.

Therefore, there is room for improvement within the art.

### BRIEF DESCRIPTION OF THE DRAWINGS

Many aspects of the cutter can be better understood with reference to the following drawings. These drawings are not necessarily drawn to scale, the emphasis instead being placed upon clearly illustrating the principles of the present cutter. Moreover, in the drawings like reference numerals designate corresponding sections throughout the several views.

FIG. 1 is an isometric view of a cutter, in accordance with an exemplary embodiment.

FIG. 2 is a schematic figure showing the cutter shown in FIG. 1 mounted to a molding assembly.

FIG. 3 is a cross-sectional view of a molding assembly incorporated with the cutter shown in FIG. 2, taken along line III-III.

FIG. 4 is a cross-sectional view of a molding assembly shown in FIG. 4.

FIG. 5 is a schematic figure showing the cutting process of the cutter shown in FIG. 3.

### DETAILED DESCRIPTION

The present cutter is provided for severing a connecting head in insert-molding.

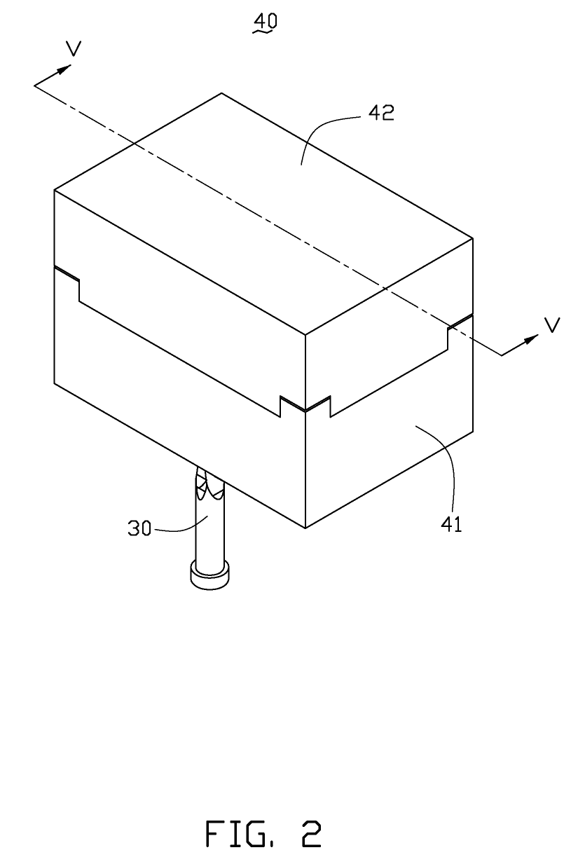

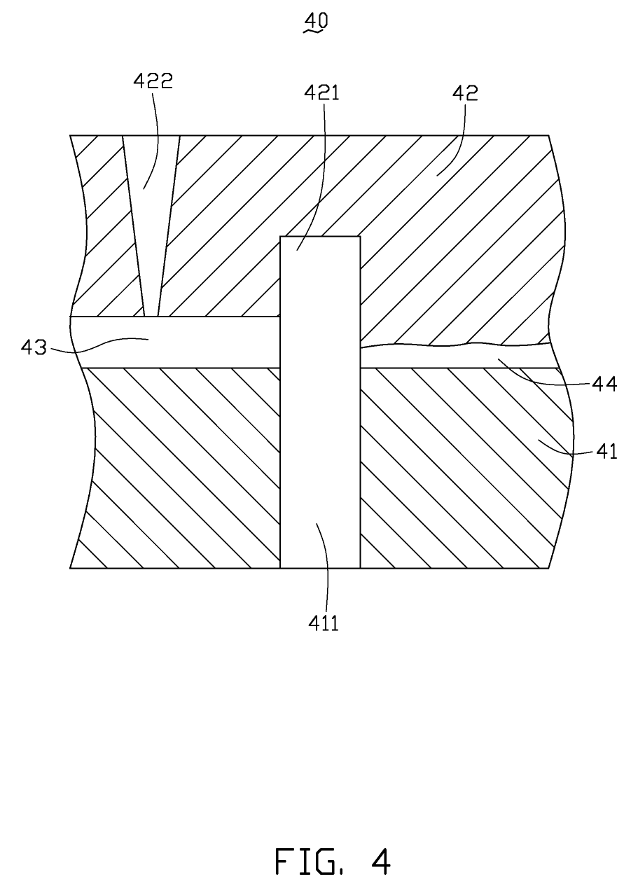

Referring to FIGS. 2 and 4, a molding assembly 40 includes a male mold 41 and a female mold 42. The male mold 41 defines a thimble hole 411. The female mold defines an receiving hole 421 corresponding to the thimble hole 411. After assembly together, the male mold 41 and the female mold 42 enclose a channel 43 and a molding chamber 44 therebetween. The female mold 42 further defines a hot-runner 422 communicating with the channel 43, so that the hot-melted plastic can be injected into the molding chamber 44 through the hot-runner 422 and the channel 43. The thimble hole 411 and the receiving hole 421 are coaxial, located between the channel 43 and the molding chamber 44, and communicate with the channel 43 and the molding chamber 44.

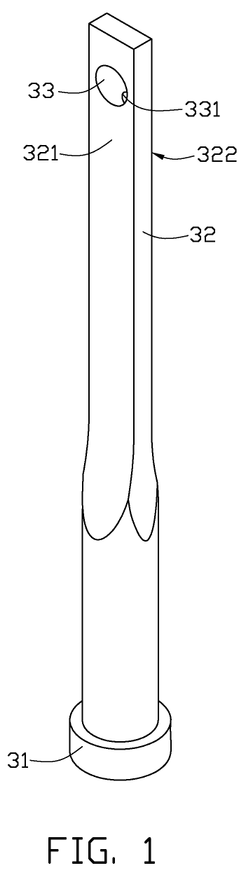

Referring to FIG. 1, the present exemplary embodiment cutter 30 includes a head portion 31 and a cutting portion 32 connected to the head portion 31. The head portion 31 is fixed to an insert-molding machine (not shown). The cutting portion 32 includes a contacting surface 321 and a stopping surface 322 opposite to the contacting surface 321. The cutter 30 defines a tapered cutting hole 33 through the contacting surface 321 and the stopping surface 322, forming a cutting chin 331 on the stopping surface 322. The cutter 30 is mounted in the thimble hole 411, with the stopping surface 322 facing the molding chamber 44 and the cutting hole 33 communicating with the channel 43 and the molding chamber 44. At this time, the stopping surface 322 partially abuts against an interior wall of the receiving hole 421 of the female mold 42. One opening of the cutting hole 33, adjacent to the contacting surface 321, is bigger than the other opening adjacent to the stopping surface 322, facilitating the flow of hot-melted plastic through the cutting hole 33 and into the molding chamber 44 during the molding process.

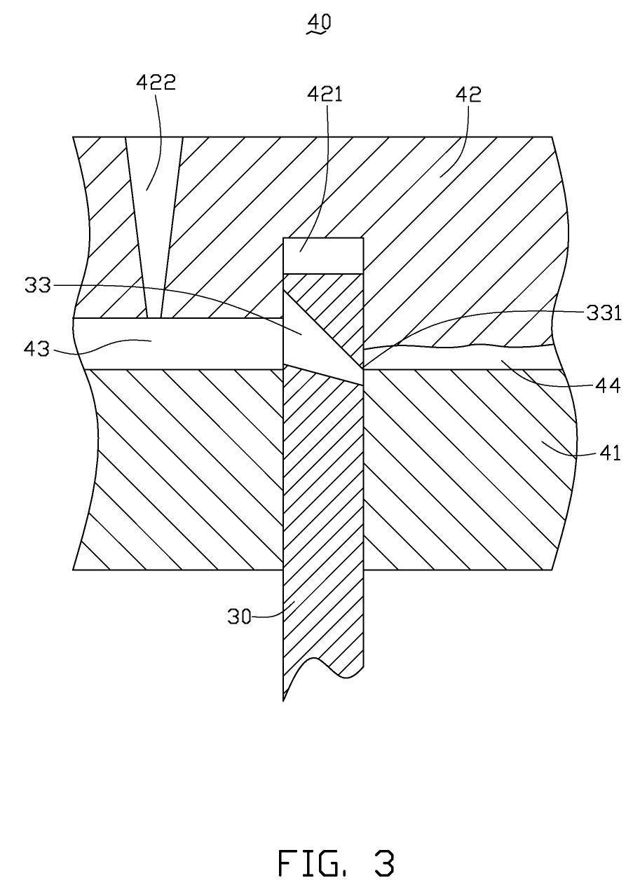

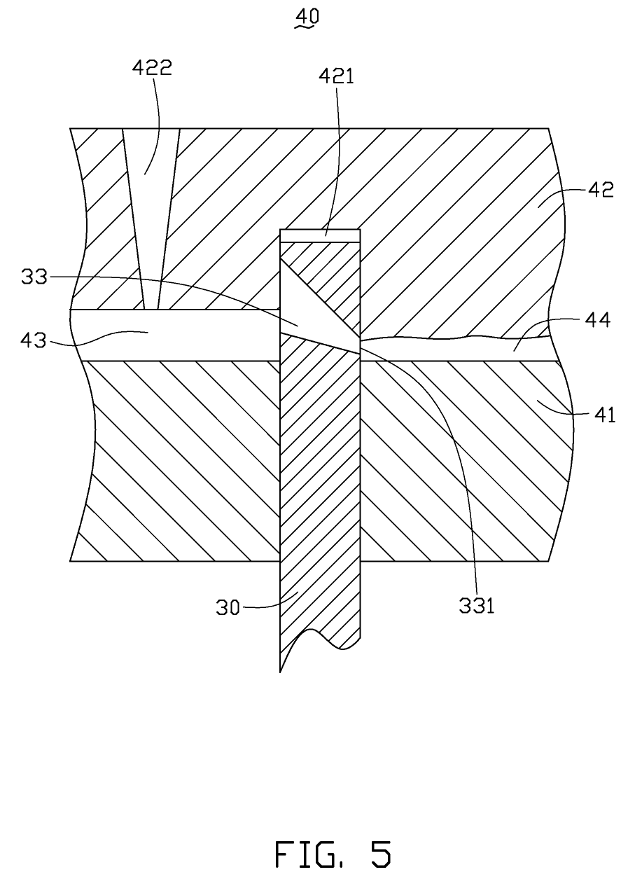

Referring to FIGS. 3 and 5, when needing to sever a connecting head formed in the channel 43 from a product formed in the molding chamber 44 along the connecting portion between the connecting head and the product and passing through cutting hole 33, the cutter 30 is triggered to move from the thimble hole 411 towards the receiving hole 421. Thereby, the cutting chin 331 severs the connecting head. During the cutting process, although as the related art mentioned, the cutter 30 is also pressed by a connecting head towards the molding chamber 44, the stopping surface 322 abuts against the interior surface of the receiving hole 421, which can prevent the cutting chin 331 from contacting/damaging the product. Thus, hits between the cutter 30 and the female mold 42 can be avoided, which effectively protects the cutter 30 and avoids burrs on the product.

In other alternative embodiment, the cutting hole 33 may be defined in other shapes, in condition that the cutting hole 33 can form the cutting chin 331 on the stopping surface 32, and allow hot-melted plastic to go through.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A cutter comprising:
a contacting surface;
a stopping surface;
wherein the cutter defines a cutting hole through the contacting surface and the stopping surface, a cutting chin formed on the stopping surface.

2. The cutter as claimed in claim 1, wherein the cutting hole is tapered, one opening of the tapered cutting hole, adjacent to the contacting surface, is bigger than the other opening, adjacent to the stopping surface.

3. A molding assembly having a cutter comprising:
a male mold defining a thimble hole, and
a female mold defining an receiving hole corresponding to the thimble hole, after assembly together, the male mold and the female mold enclose a channel and a molding chamber communicating with the channel;
the cutter is mounted in the thimble hole, the cutter including a contacting surface and a stopping surface;
wherein the cutter defines a cutting hole through the contacting surface and the stopping surface, a cutting chin formed on the stopping surface, the cutting hole communicating the channel and the chamber.

4. The molding assembly as claimed in claim 3, wherein the thimble hole and the receiving hole are coaxial and located between the channel and the molding chamber, the cutter can advance along the thimble hole to the receiving hole.

5. The cutter as claimed in claim 4, wherein the stopping surface abutting against an interior wall of the receiving hole.

6. A molding method comprising the following steps:
providing a molding assembly, the molding assembly including a male mold and a female mold, the male mold defining a thimble hole, the female defining an receiving hole;
assembling the male mold and the female mold together, the male mold and the female mold forming a channel and a molding chamber communicating with the channel;
providing a cutter, the cutter including a contacting surface and an opposite stopping surface, the cutter defining a cutting hole through the contacting surface and the stopping surface, forming a cutting chin on the stopping surface;
mounting the cutter in the thimble hole, with the cutting hole communicating the channel and the molding chamber, the stopping surface abutting against an interior wall of the receiving hole;
injecting hot-melted plastic into the molding chamber to form a product and a connecting head connected to the product;
moving the cutter along the thimble hole to the receiving hole, thus severing the connecting head from the product.
